(19) United States
(12) Patent Application Publication
(10) Pub. No.: US 2017/0070384 A1
(43) Pub. Date: Mar. 9, 2017

(54) EVENT DETECTION AND TRIGGER DEFINITION IN CONTENT DELIVERY NETWORKS

(71) Applicant: Fastly, Inc., San Francisco, CA (US)

(72) Inventor: Simon Wistow, San Francisco, CA (US)

(21) Appl. No.: 14/844,158

(22) Filed: Sep. 3, 2015

(51) Int. Cl. H04L 12/24

(52) U.S. Cl. CPC H04L 41/0803; H04L 41/18; H04L 41/22

(57) ABSTRACT

Systems, methods, apparatus, and software for detecting an event in a content delivery network include utilizing a trigger defined by an admin user. Triggers can be preconfigured or can be configurable. Data fields populated by the admin user include event-defining data fields and action-defining data fields. When event-defining data criteria are met, an event has occurred and is detected. One or more actions defined by the admin user populating the action-defining data fields can then be initiated. Detection of an event can be achieved by collecting data from the content delivery network and processing the collected data to detect when the event has occurred.

### TECHNICAL FIELD

Aspects of the disclosure are related to the field of tracking data and providing triggers that permit detection of events that occur in content delivery networks.

### TECHNICAL BACKGROUND

Network-provided content, such as Internet web pages and the like, are typically served to end users via networked computer systems. End user requests for network content are processed and the content is responsively provided over various network links These networked computer systems can include origin or hosting servers that originally host network content, such as web servers for hosting a news website. However, computer systems consisting of individual content origins or hosts can become overloaded and slow due to frequent requests of content by end users.

Content delivery networks (CDNs) add a layer of caching between content providers' original servers and end users. Content delivery networks typically have multiple distributed cache nodes that provide end users with faster access to content. When end users request content, such as a web page, the request is handled by a cache node that is configured to respond to the end user requests (instead of an origin server). Specifically, when an end user directs a content request to a given origin server, the domain name system (DNS) resolves to a cache node (frequently the node is selected as an optimized server) instead of the origin server and the cache node handles that request.

Thus a cache node acts as a proxy or cache for one or more origin servers. Various types of origin server content can be cached in the content delivery network's various cache nodes. When all or a portion of the requested content has not been cached by a cache node, that node can request the relevant content (or portion thereof) from the appropriate origin server(s) on behalf of the end user.

More specifically, when a web page is requested by an end user, a typical end user device will send a request for the web page (e.g., by clicking on a link or entering a universal resource locator (URL)) so that a browser on the end user device can load the web page's primary resource (e.g., a primary hypertext mark-up language (HTML) file, including XHTML or HTML5 files and the like). One or more additional files, referred to as sub-resources, may be referenced in that primary resource and can include secondary HTML files (files referenced by and relative to a first HTML file (primary resource)), cascading style sheet (CSS) files, JavaScript files, executable code, text files, audio files, Flash files and image files.

### OVERVIEW

Various implementations of detecting an event in a content delivery network include utilizing triggers. A trigger can be defined by an administrative user (i.e., an “admin user”) when the admin user provides specific event-defining and action-defining information relating to data fields with which the trigger is configured. Triggers can be preconfigured or can be configurable by the admin user. The data fields populated by the admin user include event-defining data fields and action-defining data fields. When the event-defining data criteria are met, an event has occurred and is detected (e.g., by an event detection and trigger definition unit or the like). One or more actions defined by the admin user using the action-defining data fields can then be initiated. Detection of an event occurrence can be achieved by collecting data from the content delivery network and processing the collected data to detect when the event has occurred.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the views. While multiple embodiments are described in connection with these drawings, the disclosure is not limited to the embodiments disclosed herein. On the contrary, the intent is to cover all alternatives, modifications, and equivalents.

FIG. 1 illustrates a communication system.

FIG. 2 illustrates a method of operation of a content delivery system.

FIG. 3A illustrates a non-limiting example of a user interface.

FIG. 3B illustrates a non-limiting example of a user interface.

FIG. 3C illustrates a non-limiting example of a user interface.

FIG. 3D illustrates a non-limiting example of a user interface.

FIG. 4 illustrates a non-limiting example of an event detection and trigger definition unit.

### DETAILED DESCRIPTION

Network content such as web content typically comprises text, hypertext markup language (HTML) pages, pictures, digital media content, video, audio, code, scripts, and/or other content viewable on and rendered by an end user device in a browser or other specialized application. Such network-provided content, such as Internet web pages and the like, is typically served to end users via networked computer systems that provide requested content over various network links A content delivery network is an example of such a networked computer system.

Content delivery network cache nodes respond to end user requests for a web page by sending requested content to such end users. Content typically is supplied to the content delivery network (and thus to end users) by content providers who are content suppliers and other customers of the content delivery network; these customers pay CDN operators to deliver the customers' content to end users. Operation of a content delivery network has the potential to generate valuable data and guidance to various parties, including administrators of content providers, other administrative content-supply-side parties and the like of the content delivery network. Such administrators can include individuals who interact with content providers (as noted above), advertisers and other parties involved in the deployment and operation of a given content delivery network.

In the present disclosure, use of a “trigger” is the use of one or more data values, points, ranges, etc. that collectively establish a set of criteria that an admin user defines using one or more event-defining data fields populated by event-defining data received from the admin user. For example, if an admin user wants to be alerted when a threshold number of users from a given family of IP addresses (e.g., assigned to a given ISP) have requested a specific web page, then a “trigger” for that would include collecting and processing data that would include (1) a given set of IP addresses, (2) a web page URL or the like, and (3) a target number of requests for that web page. When all of the event-defining criteria have been met, then an “event” has occurred (and thus can be detected) and some type of action can be initiated as a result of the event detection (e.g., an email message to the admin user). As used herein, the trigger is “configured” when the event-defining data fields or types for the required trigger criteria are selected (either (1) by use of a preconfigured trigger, or (2) by use of a user-configurable trigger—that is, a trigger that is configurable by an admin user). The trigger is then “defined” by the admin user when the event-defining data fields are populated by receiving specific data values provided by the admin user. Admin users can define events detecting end user activity (e.g., paying a bill, deploying content, logging in, etc.), CDN environment events (e.g., origin server detection failure, planned CDN maintenance) and others. An admin user may want to be alerted if changes are made to specific content being monitored, if an end user logs in from a specific geographic region, if network and/or content security are affected, etc.

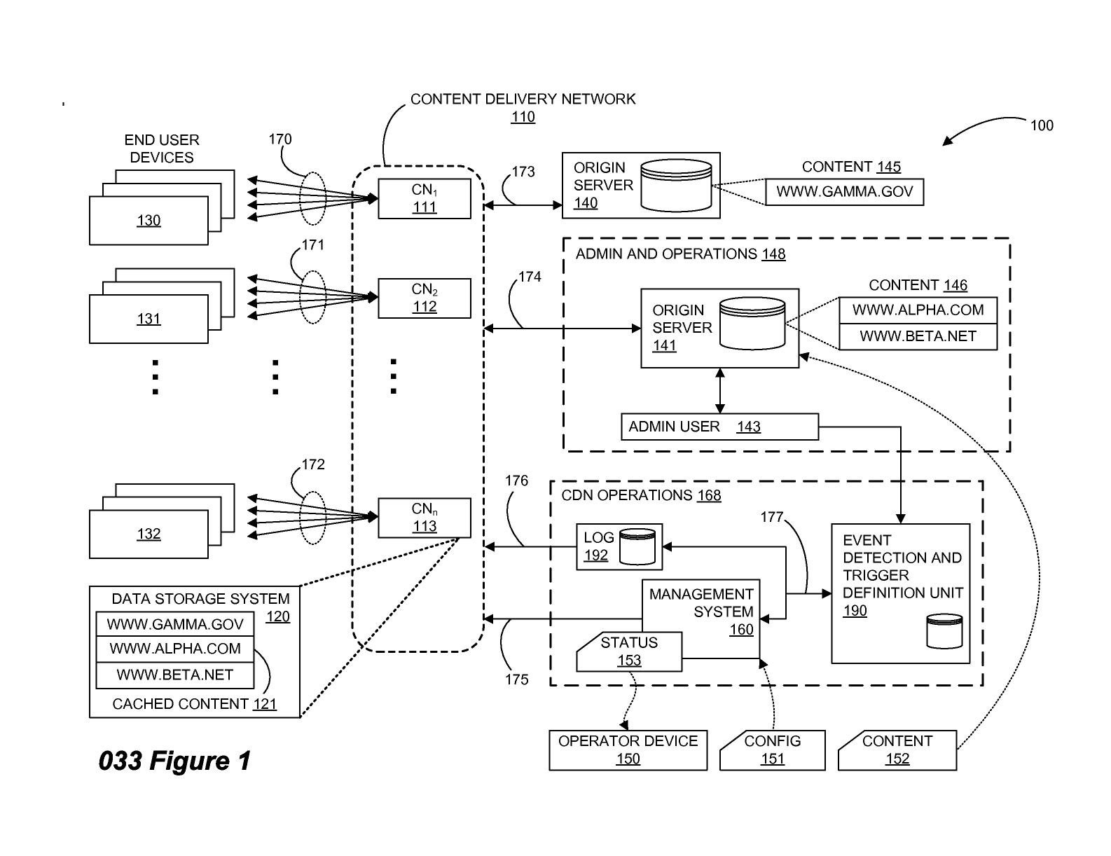

FIG. 1 illustrates an exemplary content delivery system 100 that includes content delivery network (CDN) 110, end user devices 130-132, origin servers 140-141, management system 160 and an event/trigger management unit (e.g., event detection and trigger definition unit 190—which may be a single unit or device, or may be made up of multiple units or devices working in concert). Content delivery network 110 includes one or more cache nodes (CNs) 111-113, each of which can include suitable processing resources and one or more data storage systems. Each CN 111-113 communicates with each other CN over CDN network links Each of CN 111-113 can include one or more data storage systems, such as data storage system 120 illustrated for CN 113. End user devices 130-132 are representative of a plurality of end user communication devices that can request and receive content from network 110. The transfer of content from CDN 110 to a given end user device is initiated when a specific user device 130-132 associated with a given cache node 111-113 transmits a request for content to its corresponding cache node (any number of end user devices 130-132 can be associated with a single cache node). Cache nodes 111-113 and end users 130-132 communicate over associated network links 170-172. Other network components likewise communicate over appropriate links Content delivery network 110, management system 160 and log 192 communicate over links 175, 176.

Content cached in and/or obtained by one of the CNs 111-113 is used to respond to end user requests by transmitting requested content to the end user device. As is well known in the art, CNs 111-113 can cache content from origin servers 140-141 periodically, on demand, etc. and can also seek and obtain content that is not cached by communicating directly with origin servers 140-141 (e.g., over associated network links 173-174). FIG. 1 shows cached content 121 included in data storage system 120 of cache node 113 as comprised of content 145-146. Other configurations are possible, including subsets of content 145-146 being cached in individual ones of CN 111-113. Although FIG. 1 shows content 145-146 of origin servers 140-141 being cached by data storage system 120, other content can be handled by CN 111-113. For example, dynamic content generated by activities of end user devices 130-132 need not originally reside on origin servers 140-141, and can be generated due to scripting or code included in web page content delivered by CN 111-113.

Management system 160 and its associated components collect and deliver various administrative, operational and other data, for example network and component configuration changes and status information for various parties (e.g., system operators, origin server operators, managers and the like). For example, operator device 150 can transfer configuration data 151 for delivery to management system 160, where configuration data 151 can alter the handling of network content requests by CDN 111-113, among other operations. Also, management system 160 can monitor status information for the operation of CDN 111-113, such as operational statistics, and provide status information 153 to operator device 150. Moreover, operator device 150 can transfer content 152 for delivery to origin servers 140-141 to include in content 145-146. Although one operator device 150 is shown in FIG. 1, it should be understood that this is merely representative and communication system 100 can include multiple operator devices for receiving status information, providing configuration information, or transferring content to origin servers.

With specific regard to triggers defined by admin users and implemented within network 100, FIG. 1 illustrates one or more implementations of a trigger definition system, where admin users can include (but are not limited to) individuals associated with various types of parties such as content providers, advertisers and others. Event detection and trigger definition unit 190 is connected to various aspects of the CDN operation (e.g., management system 160 and/or log 192 via link 177, perhaps others). Origin server 141 of FIG. 1 is part of administration and operations 148 that also include an admin user unit 143, which can be one or more specialized or specially-configured computers and associated apparatus. The admin user unit 143 is in communication with the CDN's event detection and trigger definition unit 190 through any suitable means. Implementations of admin user unit 143 can provide admin user personnel with graphical and/or other admin user means for communicating with unit 190, as noted in connection with various implementations disclosed herein. Unit 190 may also be connected to various other components of the admin user unit 143 and/or other content delivery network contact points in order to carry out actions that are initiated (e.g., invoked or otherwise called for) when an event is detected using defined triggers.

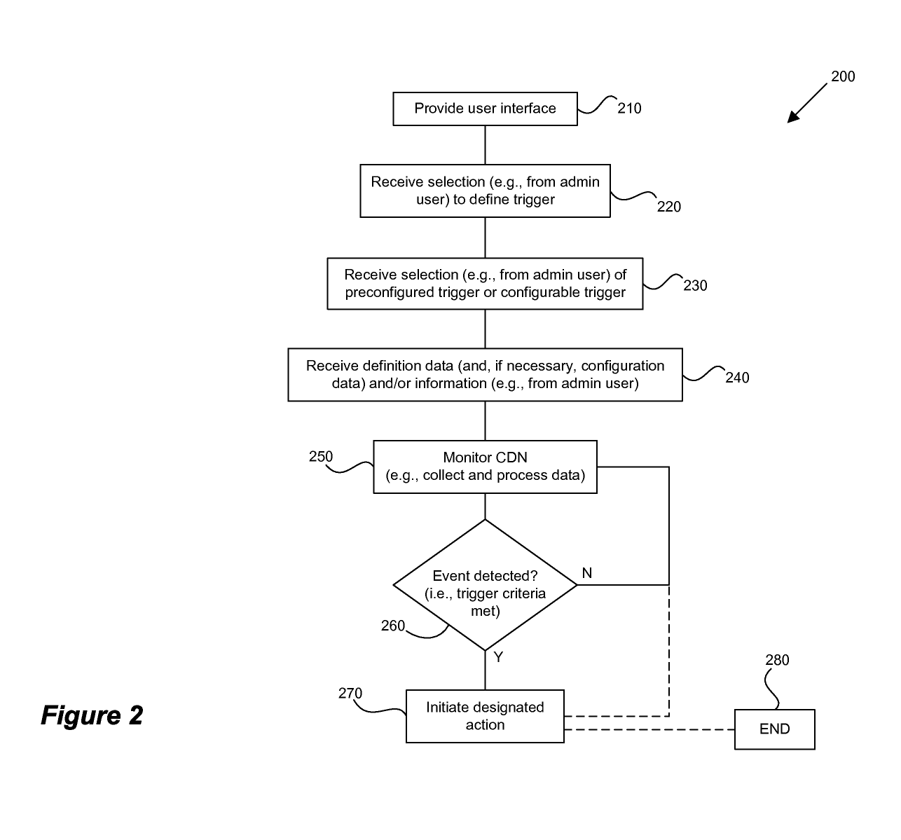

FIG. 2 illustrates one or more non-limiting examples of a method of operation 200 of a content delivery network implementing definition of one or more triggers by an admin user or the like. Software stored on or in the event detection and trigger definition unit 190 and/or one or more other locations can be used to implement one or more methods and can comprise computer program instructions, firmware, or some other form of machine-readable processing instructions having processes that, when executed by a processing system, direct a content delivery network to operate as described herein.

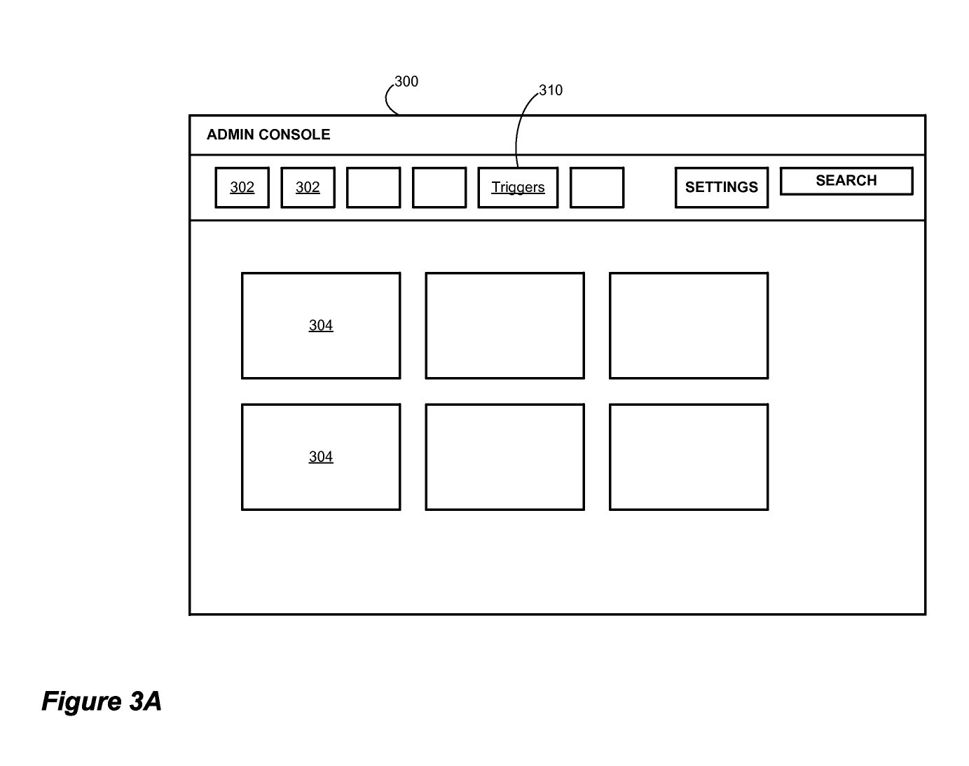

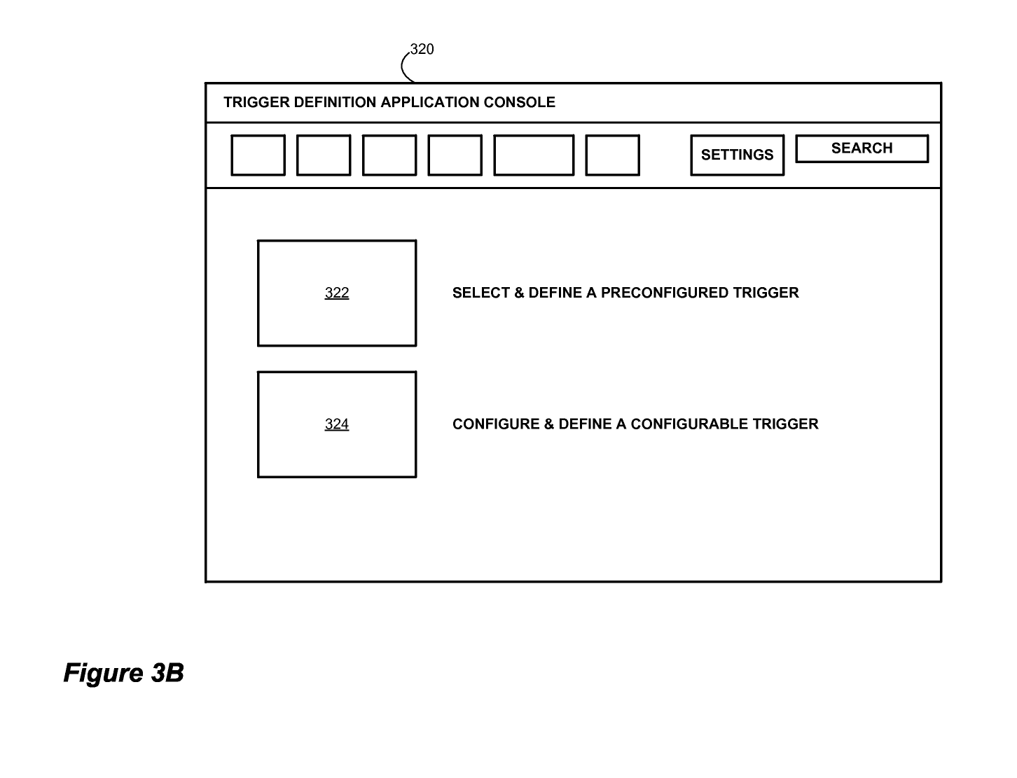

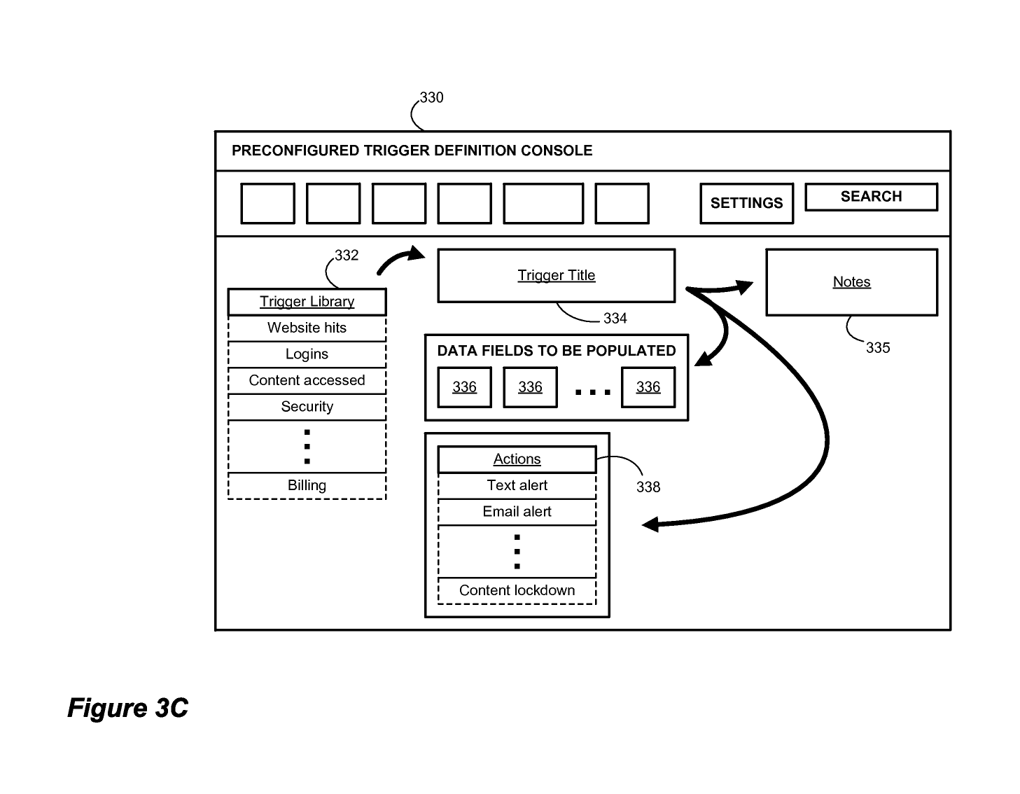

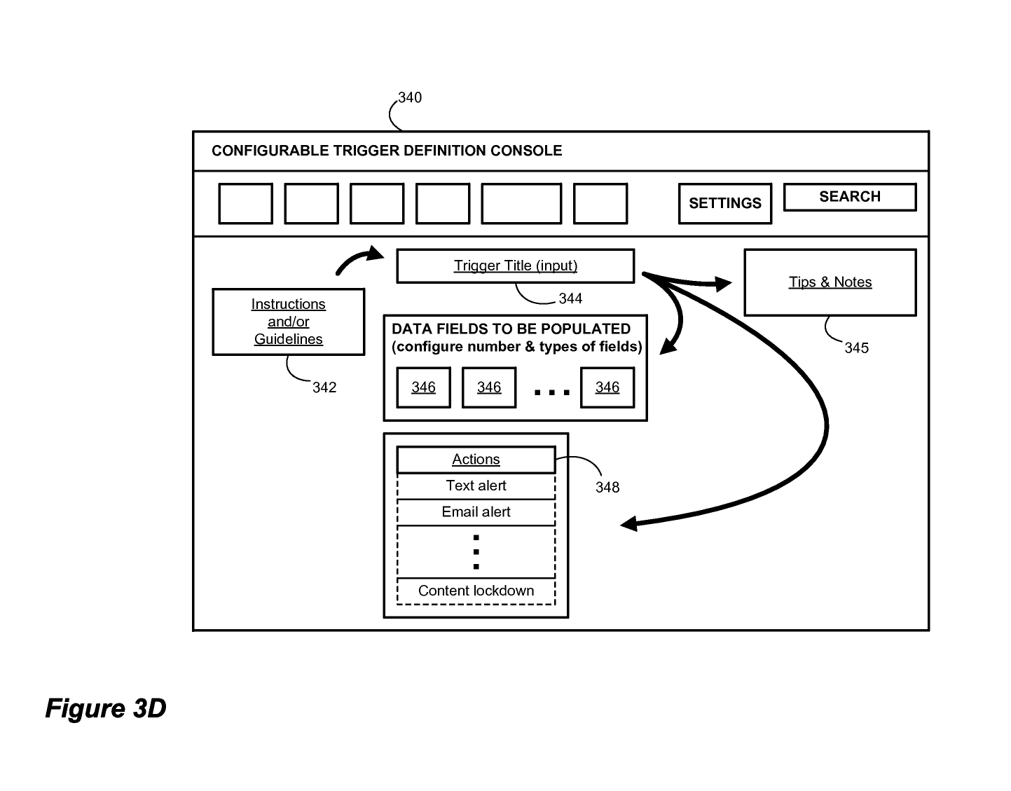

In method of operation 200 for detecting an event and initiating action using a defined trigger, a content delivery network provides a user interface (210), for example to provide an admin user with a variety of selection options for the admin user's CDN account or the like. The content delivery network (e.g., a trigger definition unit or the like) then receives a selection of the trigger definition application (220), for example when an admin user selects a button or other indicator on a user interface or the like (e.g., a GUI, text interface, email). The CDN (e.g., a trigger definition unit or the like) then receives a selection (e.g., from an admin user) of the type of trigger to define—in this implementation, either a preconfigured trigger or a configurable trigger (230). Again, this selection can be made by selecting a button or other indicator on a GUI for electronic display or the like. The CDN then receives any information needed to define (and, if necessary, configure) the selected trigger (240).

Where an admin user selects a preconfigured trigger, one or more or more event-defining data fields may be presented for population by the admin user to define the trigger's criteria (which, when met, constitute a detected “event”) and any actions to be taken when the trigger criteria are met. Non-limiting examples of such preconfigured trigger event-defining data and other fields and GUI layout (e.g., available for electronic display to the admin user) are shown in FIGS. 3A-3D. The admin user can also select an expiration date/time and other event-defining trigger controls and/or limitations in some implementations. If conditions or other circumstances change, an admin user can cancel or update any defined triggers.

When the admin user selects a configurable trigger, additional information typically is needed to set up (i.e., configure), define and execute the requested monitoring and action(s). For example, the admin user can assign a name or other designation to each configurable trigger. The configurable trigger can be dependent upon a combination of criteria that permit customization of each trigger; in such cases the admin user can designate the types of data that will be used to determine whether an event has occurred and is detected.

The CDN then monitors the network (250), for example by collecting and processing data available to management system 160, log 192 and/or other CDN components or the like. When criteria for the defined trigger are met and an event is detected (260), the CDN then performs the process and/or takes the defined action (270). If the trigger is defined to be an ongoing monitoring process or the like, then monitoring for event detection is continued (250). If the trigger is a one-time event detection type of process, then the method 200 ends (280). Non-limiting examples of event-triggered actions can include alerting the admin user of a given event's occurrence and detection, affecting the admin user's CDN account and/or affecting an end user's account with the admin user, notifying the admin user (e.g., by email, text message) of the event, affecting operation of the CDN with regard to a particular end user, etc. Other examples and implementations relating to the method of operation implementations are disclosed herein and will be apparent to those skilled in the art after reviewing this disclosure.

In such method implementations (including those implemented in software and/or by other means), the method of operation renders a technical effect by allowing various parties (e.g., admin users) to use content delivery network data and operations for monitoring, event detection, and initiating action via the interfacing of the CDN's operations and data collection with the other parties' administrative resources and apparatus. Such interaction provides better control and deployment of content, resources and services in a content delivery network in which the method of operation is in use.

Various CDN interface modes and apparatus can be used to implement defined triggers. FIGS. 3A-3D illustrate implementations of interfaces for electronic display that can be used to facilitate definition (and, if necessary, configuration) of one or more triggers by an admin user. FIG. 3A provides a non-limiting example of an admin console that can be used to provide a CDN admin user with options for reviewing account and/or other information, content updates, etc. Among the options offered to an admin user on console 300 are selection buttons 302 (e.g., applications, utilities, etc.) and other selection panels 304 (e.g., account history and/or status, billing, etc.). Such a console can be provided to a admin user unit 143 or the like via software. Included in the non-limiting example of FIG. 3A is button 310 for “Triggers” that allows an admin user to select a trigger definition application. FIG. 3B illustrates a sample trigger definition application console 320 that provides an admin user with the option of selecting a trigger definition mode—either a preconfigured trigger mode selected using button 322 or a configurable trigger mode selected using button 324.

FIG. 3C illustrates a non-limiting example of a preconfigured trigger definition console 330. An admin user selecting a preconfigured trigger can use console 330 to define a trigger available from a library or the like. A drop-down menu 332 can enumerate available preconfigured triggers. A search function might also be available to allow an admin user to locate a preconfigured trigger. When the desired trigger is found and selected, its title appears in a heading 334 and appropriate event-defining data fields 336 and action options 338 (e.g., in a drop-down menu) are presented to the admin user. When the admin user has selected a preconfigured trigger, along with title 334, the trigger definition unit can provide “Notes” and/or other information to the admin user that explain what the trigger is intended to monitor, the event(s) it is intended to detect, and the types of actions that can be taken. Such information can assist in informing the admin user's decision to utilize a given preconfigured trigger.

The event-defining data fields populated by the admin user during trigger definition can include maximum values, minimum values, ranges, aggregate counts or other accumulations of discrete occurrences, geographic locations of end users, IP address(es), and other data that are available in a content delivery network and are useful for various parties using or participating in the CDN. Action options 338 can include text alerts to the admin user, email alerts to the admin user, various account-related actions, locking down of content, and other actions that are useful for admin users. If a CDN operator finds that is a significant number of specific triggers or types of triggers being configured using the configurable trigger process, the library of preconfigured triggers can be expanded so that admin users are not required to configure customized triggers using the configurable trigger mode.

FIG. 3D illustrates a non-limiting example of a configurable trigger definition console 340. In this implementation an admin user may name and configure a more customized trigger. The admin user can be provided with “Instructions and/or Guidelines” 342 before inputting the trigger title 344 and deciding how many and what types of event-defining data fields 346 to configure and utilize in connection with the configurable trigger. Preconfigured and/or configurable actions 348 can be presented as well—in some implementations an admin user may have the ability to configure actions, depending on the degree of interaction permitted between the admin user and the content delivery network. As the admin user progresses through the trigger definition process, “Tips & Notes” 345 or the like may be provided to guide selection and population of event-defining data and/or other fields.

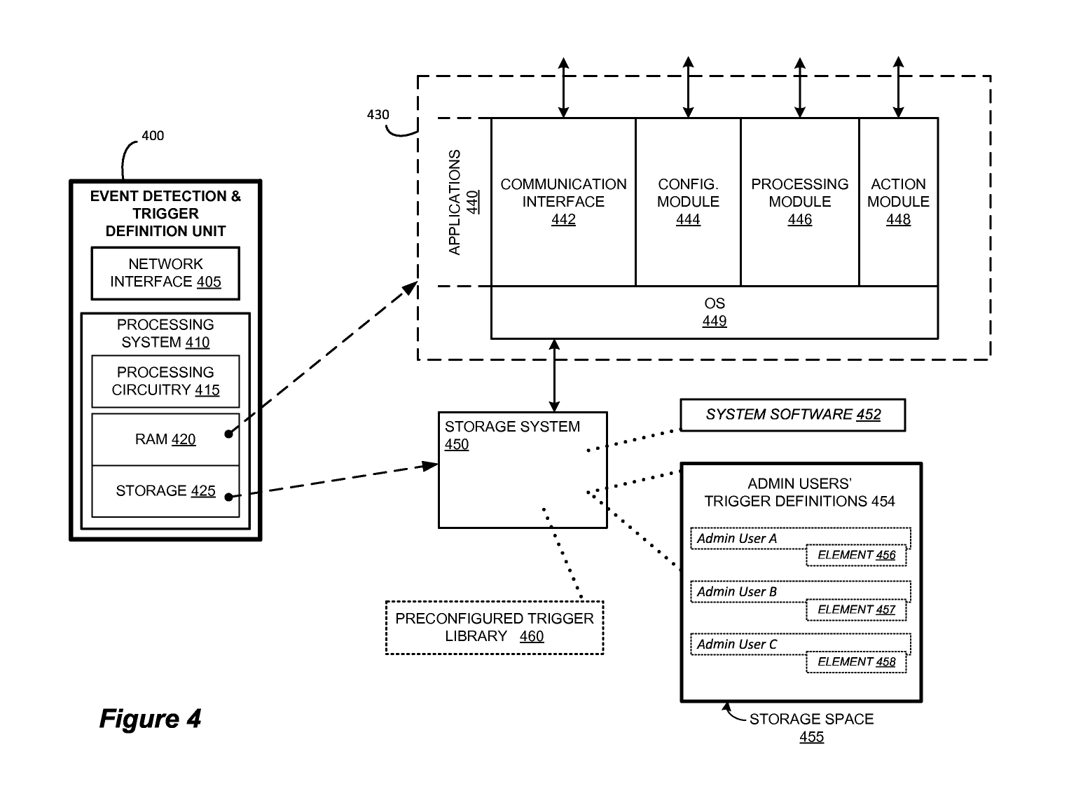

To further describe one or more implementations of the equipment and operation of an event detection and trigger definition unit in a content delivery network, FIG. 4 illustrates a non-limiting example of an event detection and trigger definition unit 400. Unit 400 can be an example of event detection and trigger definition unit 190 of FIG. 1, although variations are possible. Unit 400 includes network interface 405 and processing system 410, although further elements can be included. Processing system 410 includes processing circuitry 415, random access memory (RAM) 420, and storage 425, although further elements can be included. Exemplary contents of RAM 420 are further detailed in RAM space 430, and exemplary contents of storage 425 are further detailed in storage system 450.

Processing circuitry 415 can be implemented within a single processing device but can also be distributed across multiple processing devices or sub-systems that cooperate in executing program instructions. Examples of processing circuitry 415 include general purpose central processing units, microprocessors, application specific processors, and logic devices, as well as any other type of processing device. In some examples, processing circuitry 415 includes physically distributed processing devices, such as cloud computing systems.

Network interface 405 includes one or more network interfaces for communicating over communication networks, such as packet networks, the Internet, and the like. The network interfaces can include one or more local or wide area network communication interfaces which can communicate over Ethernet or Internet protocol (IP) links Network interface 405 can include network interfaces configured to communicate using one or more network addresses, which can be associated with different network links Examples of network interface 405 include network interface card equipment, transceivers, modems, and other communication circuitry. In some implementations the network interface 405 provides the communications link with an admin user (i.e., an admin user device) configuring one or more triggers using unit 400.

RAM 420 and storage 425 together can comprise a non-transitory data storage system, although variations are possible. RAM 420 and storage 425 can each comprise any storage media readable by processing circuitry 415 and capable of storing software. RAM 420 can include volatile and nonvolatile, removable and non-removable media implemented in any method or technology for storage of information, such as computer readable instructions, data structures, program modules, or other data. Storage 425 can include non-volatile storage media, such as solid state storage media, flash memory, phase change memory, magnetic memory, or as illustrated by storage system 450 in this example. RAM 420 and storage 425 can each be implemented as a single storage device but can also be implemented across multiple storage devices or sub-systems. RAM 420 and storage 425 can each comprise additional elements, such as controllers, capable of communicating with processing circuitry 415. In some implementations, the storage media can be a non-transitory storage media. In some implementations, at least a portion of the storage media can be transitory. It should be understood that in no case are the storage media propagated signals.

Software stored on or in RAM 420 or storage 425 can comprise computer program instructions, firmware, or some other form of machine-readable processing instructions having processes that, when executed by a processing system, direct unit 400 to operate as described herein. For example, software drives unit 400 to receive admin user selections, instructions and information concerning preconfigured triggers and configurable triggers; to monitor, collect and process content delivery network data; to determine when an event is detected; to initiate notifications, alerts and other communications; and to initiate other action as a result of the detection of an event (i.e., when trigger criteria are met). The software also can include user software applications. The software can be implemented as a single application or as multiple applications. In general, the software can, when loaded into a processing system and executed, transform the processing system from a general-purpose device into a special-purpose device customized as described herein.

RAM space 430 illustrates a detailed view of an non-limiting, exemplary configuration of RAM 420. It should be understood that different configurations are possible. RAM space 430 includes applications 440 and operating system (OS) 449. RAM space 430 includes RAM space for temporary storage of various types of data, such as dynamic random access memory (DRAM).

Applications 440 include communication interface 442, configuration module 444, processing module 446, and action module 448. Communications interface 442 handles communications among and between one or more admin users, one or more other parties, one or more event detection and trigger definition units 400 and one or more content delivery networks.

Applications 440 and OS 449 can reside in RAM space 430 during execution and operation of unit 400, and can reside in a system software storage space 452 on storage system 450 during a powered-off state, among other locations and states. Applications 440 and OS 449 can be loaded into RAM space 430 during a startup or boot procedure as described for computer operating systems and applications.

Communication interface 442, configuration module 444, processing module 446 and action module 448 each allow interaction between and exchange of data with components of unit 400. In some examples, each of communication interface 442, configuration module 444, processing module 446 and action module 448 comprise an application programming interface (API). Communication interface 442 allows for exchanging data, messages, etc. in unit 400 by modules 444, 446, 448, and can also receive instructions to purge or erase data from unit 400. Configuration module 444 allows for configuring of various operational features of unit 400 based on admin user definitions of preconfigured triggers and configurable triggers.

Processing module 446 is configured to process data collected from the content delivery network and to detect when an event has occurred or when other trigger criteria are met. Action module 448 is configured to initiate actions defined and/or designated by an admin user that are triggered when the trigger criteria are met. This can include the action module 448 interacting with other components, modules, etc. of unit 400 and/or the broader content delivery network.

Communication interface 442, configuration module 444, processing module 446 and action module 448 can each communicate with external systems via network interface 405 over any associated network links. In further examples, one or more of elements 442, 444, 446, 448 are implemented in VCL or VCL modules.

Storage system 450 illustrates a detailed view of a non-limiting, exemplary configuration of storage 425. Storage system 450 can comprise flash memory such as NAND flash or NOR flash memory, phase change memory, magnetic memory, among other solid state storage technologies. As shown in FIG. 4, storage system 450 includes system software 452, as well as defined triggers 454 (which, for example, can be preconfigured triggers that admin users have defined and/or configurable triggers that have been defined), which are stored in storage space 455. As described above, system software 452 can be a non-volatile storage space for applications 440 and OS 449 during a powered-down state of trigger definition unit 400, among other operating software. Defined triggers 454 includes stored data including values, parameters, names, action selections, etc. that define each trigger being implemented. In the non-limiting example of FIG. 4, trigger definitions 454 include identification and definitions for Admin User A (e.g., stored in element 456), Admin User B (e.g., stored in element 457), and Admin User C (e.g., stored in element 458).

In implementations where a trigger definition unit implements preconfigured triggers, a library of such preconfigured triggers can be used. Storage system 450 can therefore also include a preconfigured trigger library 460, which can be updated by unit 400 and/or from other sources of information (e.g., the CDN operator) via network interface 405.

Event detection and trigger definition unit 400 is generally intended to represent a computing system with which at least software 430 and 449 are deployed and executed in order to render or otherwise implement the operations, methods and processes described herein. However, trigger definition unit 400 can also represent any computing system on which at least software 430 and 449 can be staged and from where software 430 and 449 can be distributed, transported, downloaded, or otherwise provided to yet another computing system for deployment and execution, or yet additional distribution.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method of operating a content delivery network (CDN) to detect a CDN event, the method comprising:
defining a CDN trigger for the CDN event, the trigger being defined by one or more event-defining data criteria, wherein the event occurs when the one or more event-defining data criteria are met, wherein defining the CDN trigger comprises:
a processor receiving an admin user selection indicating a request to define the CDN trigger; and
responsive to receiving the admin user selection, the processor providing a user interface for electronic display to the admin user, wherein the user interface provides multiple fields configured to be populated by receiving admin user trigger definition data, the multiple fields comprising:
one or more event-defining data fields, each event-defining data field configured to receive event-defining data input; and
one or more action fields, each action field identifying an action to be initiated by the content delivery network when the event occurs.

2. The method of claim 1 further comprising receiving an admin user selection to define one of the following:
a configurable trigger;
a preconfigured trigger.

3. The method of claim 1 wherein the one or more action fields comprise one or more of the following selectable options:
initiating a text message;
initiating an email message;
an admin user account-related action;
locking down content.

4. The method of claim 1 wherein each event-defining data field is configured to receive one or more of the following:
a maximum data value;
a minimum data value;
a data range value;
geographic identification information;
IP address information;
date-related information.

5. The method of claim 1 further comprising:
collecting data from the content delivery network; and
processing the collected data to determine whether the event has occurred; and
initiating an action defined by the one or more action fields when the event occurs.

6. A computer apparatus to operate an event detection and trigger definition unit in a content delivery network (CDN), the computer apparatus comprising processing instructions that direct the event detection and trigger definition unit, when executed by the event detection and trigger definition unit, to:
receive an admin user selection indicating a request to define a CDN trigger; and
responsive to receiving the admin user selection, provide a user interface for electronic display to the admin user, wherein the user interface provides multiple fields configured to be populated by receiving trigger definition data, the multiple fields comprising:
one or more event-defining data fields, each event-defining data field configured to receive event-defining data input; and
one or more action fields, each action field identifying an action to be initiated by the content delivery network when the event occurs.

7. The computer apparatus of claim 6 wherein the processing instructions further direct the trigger definition unit to receive an admin user selection to define one of the following:
a configurable trigger;
a preconfigured trigger.

8. The computer apparatus of claim 6 wherein the one or more action fields comprise one or more of the following selectable options:
initiating a text message;
initiating an email message;
an admin user account-related action;
locking down content.

9. The computer apparatus of claim 6 wherein each event-defining data field is configured to receive one or more of the following:
a maximum data value;
a minimum data value;
a data range value;
geographic identification information;
IP address information;
date-related information.

10. The computer apparatus of claim 6 wherein the processing instructions further direct the trigger definition unit to:
collect data from the content delivery network; and
process the collected data to determine whether the event has occurred; and
initiate an action defined by the one or more action fields when the event occurs.

11. A method of detecting an event in a content delivery network, the method comprising:
defining a trigger for the event, wherein defining the trigger comprises:
a processor receiving an admin user selection indicating a request to define the trigger; and
responsive to receiving the admin user selection, the processor providing a user interface for electronic display to the admin user, wherein the user interface provides multiple fields configured to be populated by receiving trigger definition data, the multiple fields comprising:
one or more event-defining data fields, each event-defining data field configured to receive event-defining data input; and
one or more action fields, each action field identifying an action to be initiated by the content delivery network when the event occurs;
collecting data from the content delivery network;
processing the collected data to detect when the event has occurred; and
initiating an action defined by the one or more action fields when the event is detected.

12. The method of claim 11 further comprising receiving an admin user selection to define one of the following:
a configurable trigger;
a preconfigured trigger.

13. The method of claim 12 wherein the preconfigured trigger is selected from a plurality of preconfigured triggers maintained in a library.

14. The method of claim 11 wherein the one or more action fields comprise one or more of the following selectable options:
initiating a text message;
initiating an email message;
an admin user account-related action;
locking down content.

15. The method of claim 11 wherein each event-defining data field is configured to receive one or more of the following:
a maximum data value;
a minimum data value;
a data range value;
geographic identification information;
IP address information;
date-related information.
